(19) United States
(12) Patent Application Publication
(10) Pub. No.: US 2005/0081836 A1
(43) Pub. Date: Apr. 21, 2005

(54) Four cylinder engine with internal exhaust gas recirculation

(75) Inventor: Richard Edward Winsor, Waterloo, IA (US)

Correspondence Address: Joel S. Carter;Patent Department, DEERE & COMPANY, One John Deere Place, Moline, IL, 61265-8098, US

(73) Assignee: Deere & Company, a Delaware corporation

(21) Appl. No.: 10/690,357

(22) Filed: Oct. 21, 2003

(51) Int. Cl. F02M 25/07

(52) U.S. Cl. 123/568.14

(57) ABSTRACT

The entire right, title and interest in and to this application and all subject matter disclosed and/or claimed therein, including any and all divisions, continuations, reissues, etc., thereof are, effective as of the date of execution of this application, assigned, transferred, sold and set over by the applicant(s) named herein to Deere & Company, a Delaware corporation having offices at Moline, Ill. 61265, U.S.A., together with all rights to file, and to claim priorities in connection with, corresponding patent applications in any and all foreign countries in the name of Deere & Company or otherwise.

### BACKGROUND

The present invention relates to an internal combustion engine with exhaust gas recirculation “EGR”.

It is known to use EGR to reduce NOx (oxides of nitrogen) emissions from engines. However, EGR normally requires a conduit and a control valve to control communication of exhaust gas from the exhaust manifold to the intake manifold, such as described in U.S. Pat. No. 6,230,696 issued in May 2001 to Veit et al. Such conduit and valve adds undesirable cost to an engine. To avoid such costs, internal EGR has been proposed, wherein exhaust gas is retained or added to the cylinder contents without any external piping. This may be accomplished by modifying the timing of the opening of the intake and/or exhaust valves and/or by having a second opening of the intake and/or exhaust valves during the engine cycle.

For example, it has been proposed to achieve internal EGR by pre-opening the intake valve during the exhaust stroke of the piston so that exhaust gasses flow into the intake port. Then the exhaust gasses are inducted back into the cylinder during the piston intake stroke. However, with such a method, the amount of fresh air which is sucked into the cylinder is reduced because some of the fresh air is replaced by the exhaust gasses from the previous cycle.

A “pulse EGR system” using exhaust valve re-opening has been developed by Hino Motors and is designed to introduce exhaust gas back into the cylinder through the exhaust valve port with a special sub-lift lobe on the camshaft. Similar concepts are described “The Potential of a Combined Miller Cycle and Internal EGR Engine for Future Heavy Duty Truck Applications”, SAE 980180, 1998. However, these exhaust valve re-opening systems are shown with a conventional six cylinder engine. A divided exhaust manifold is almost universally used on six cylinder engines because it provides greater pulse energy (from the cylinder blowdown process) to the turbocharger. However, in the case of a six-cylinder engine with the normal firing order of 1-5-3-6-2-4, cylinder 1 should be charged with exhaust by blowdown from cylinder 6, but with a divided exhaust manifold, the pulse does not reach cylinder 1, because cylinder 6 and 1 exhaust into different banks of the manifold. Similarly, cylinder 5 should be charged with exhaust by blowdown from cylinder 2, but again with a divided exhaust manifold, the pulse does not reach cylinder 5. Furthermore, in a normal six-cylinder engine with an open exhaust manifold, the relatively large manifold volume causes the exhaust blowdown pulses to be weaker by the time they reach the cylinder having the secondary valve opening. As a result, secondary exhaust valve opening cannot achieve sufficient internal EGR in a normal six-cylinder engine with a divided exhaust manifold.

Both intake valve pre-opening and the second exhaust valve opening result in a reduction in the mass of inducted fresh air of about twice the mass of hot residual gas, and this is undesirable because the lack of air increases smoke and reduces engine output.

### SUMMARY

Accordingly, an object of this invention is to provide an internal combustion engine having reduced emissions.

A further object of the invention is to provide such an engine which does not require a conduit or a control valve.

A further object of the invention is to provide such an engine which does not require a variable valve mechanism.

These and other objects are achieved by the present invention, wherein a four cylinder engine is provided with an undivided exhaust manifold and is provided with a mechanism for producing a secondary exhaust valve opening near the end of the intake valve opening. In such an engine, a simple reopening of the exhaust valve at the end of the intake stroke adds internal EGR to the cylinder with minimal loss of fresh air. Such an engine will have a normal exhaust process, followed by a normal intake process until late in the intake stroke. At this time, the exhaust valve begins opening and air starts to leave the cylinder due to low pressure in the exhaust manifold. Shortly thereafter, the exhaust manifold pressure rises rapidly because another cylinder begins discharging into the exhaust manifold. This forces the air in the exhaust port back into the cylinder with the late re-opened exhaust valve, followed by exhaust gas. Relatively little of the cylinder contents can escape through the intake port because the intake valve is almost closed when the exhaust pressure pulse arrives. As a result, both exhaust gas and extra air are trapped in the cylinder.

### BRIEF DESCRIPTION OF THE DRAWINGS

FIG. 1 is a simplified schematic view of a four cylinder internal combustion engine with an undivided exhaust manifold;

FIG. 2 is a partial sectional view of one of the cylinders of the engine of FIG. 1;

FIG. 3 is a valve timing diagram showing the timing of the intake and exhaust valves of FIG. 2 according to the present invention.

### DETAILED DESCRIPTION

Referring to FIG. 1, a four-stroke cycle, four-cylinder reciprocating internal combustion engine 10 has four cylinders 12a-12d, an intake manifold 14, intake inlets 15a-15d, and a turbocharger 16. The exhaust outlet pipes 18a-18d from each cylinder are communicated to an undivided exhaust manifold 20 which is communicated to the turbocharger 16 via a single exhaust conduit 22.

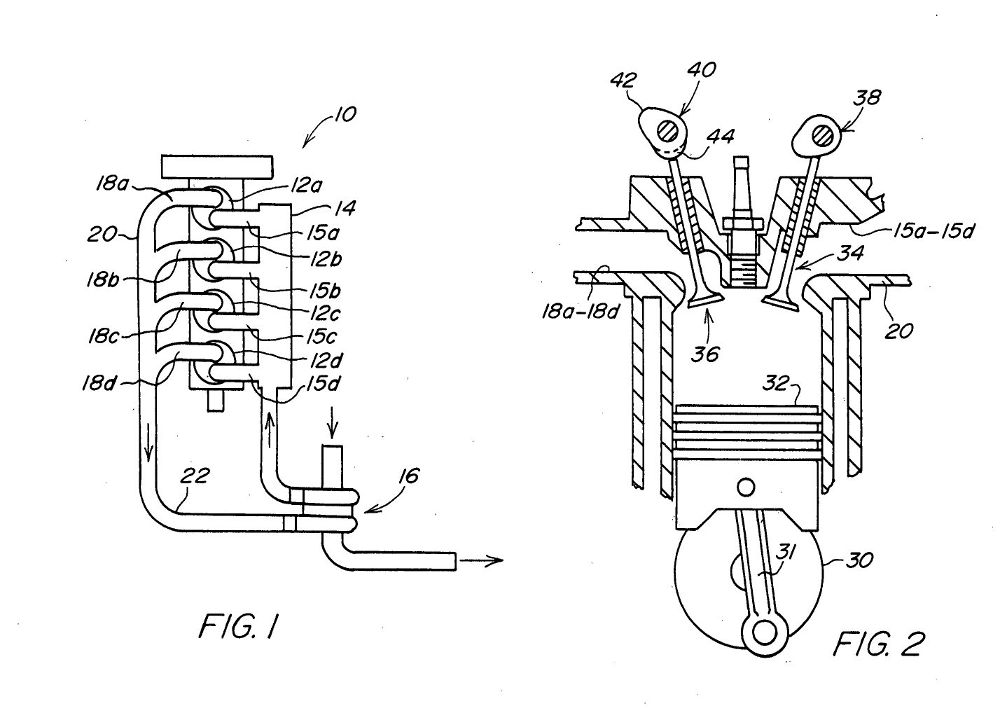

Referring now to FIG. 2, a piston 32 reciprocates within each of the cylinders 12a-12d, and each piston 32 is coupled to a crankshaft 30 by a conventional piston rod 31. Each cylinder has an intake poppet valve 34 and an exhaust poppet valve 36. An intake camshaft 38 operates the intake valves 34, and an exhaust camshaft 40 operates the exhaust valves 36. The exhaust camshaft 40 has a primary lobe 42 and a secondary lobe 44.

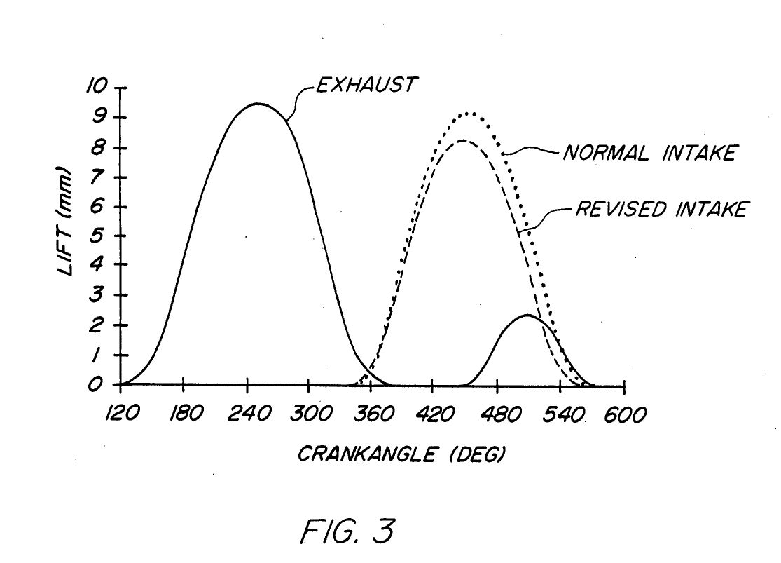

As illustrated by FIG. 3, each primary lobe 42 opens the corresponding exhaust valve 36 during an exhaust stroke of the corresponding piston 32. Each secondary lobe 44 opens the corresponding exhaust valve 36 near an end of an intake stroke of the corresponding piston 32. As a result, a pressure pulse in the exhaust manifold 20 causes a portion of the exhaust gases to recirculate from the exhaust manifold 20 and back into the corresponding one of the cylinder 12a-12d via the open exhaust valve 36.

The engine described above and using late second exhaust valve opening for internal EGR has a normal exhaust process, followed by a normal intake process until late in the intake stroke of the piston 32. At this time, the exhaust valve 36 begins opening and air starts to leave the cylinder due to low pressure in the exhaust manifold 20. Shortly thereafter, the pressure in the exhaust manifold 20 rises rapidly because another cylinder begins discharging into the exhaust manifold 20. This forces the air in the exhaust port 18a-18d back into the cylinder 32 of interest, followed by exhaust gas. Relatively little of the cylinder contents can escape through the intake port 15a-15d because the intake valve 34 is almost closed when the exhaust pressure pulse arrives. Also, as shown in FIG. 3, the intake valve 34 can be closed slightly earlier than normal in order to minimize this loss of air from the cylinder back into the intake port 15a-15d.

This results in a low-cost NOx control using internal EGR which is beneficial for engines where cost is more important than fuel economy. Late second exhaust valve opening is a superior method of adding internal EGR to a four-cylinder engine because of the relatively small loss in fresh air at higher speeds and the lower level of internal EGR at lower speeds. Also, less fresh air is lost with this method of introducing internal EGR as compared to other methods.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

1. A four-stroke cycle, four-cylinder reciprocating internal combustion engine having a crankshaft, four pistons, each reciprocal within a corresponding one of the cylinders, an intake poppet valve and an exhaust poppet valve for each cylinder, an intake camshaft for operating the intake valves, and an exhaust camshaft for operating the exhaust valves, the exhaust camshaft having primary lobes, each primary lobe normally opening the corresponding exhaust valve during an exhaust stroke of the corresponding piston, wherein:
the engine has an undivided exhaust manifold; and
the exhaust camshaft has secondary lobes, each secondary lobe opening the corresponding exhaust valve near an end of an intake stroke of the corresponding piston, whereby a pressure pulse in the exhaust manifold causes a portion of the exhaust gases to recirculate from the exhaust manifold and into the corresponding cylinder.

2. The engine of claim 1, further comprising:
means for closing the intake valve slightly earlier than normal.

3. The engine of claim 1, further comprising:
means for closing the intake valve slightly before the exhaust valve is closed by the secondary lobe.

4. A four-stroke cycle, four-cylinder reciprocating internal combustion engine having a crankshaft, four pistons, each reciprocal within a corresponding one of the cylinders, an intake poppet valve and an exhaust poppet valve for each cylinder, an intake camshaft for operating the intake valves, and an exhaust camshaft for operating the exhaust valves, the exhaust camshaft having primary lobes, each primary lobe normally opening the corresponding exhaust valve during an exhaust stroke of the corresponding piston, wherein:
the engine has an undivided exhaust manifold;
the exhaust camshaft has secondary lobes, each secondary lobe opening the corresponding exhaust valve near an end of an intake stroke of the corresponding piston, whereby a pressure pulse in the exhaust manifold causes a portion of the exhaust gases to recirculate from the exhaust manifold and into the corresponding cylinder; and
the intake camshaft closes the intake valve slightly before the exhaust valve is closed by the secondary lobe.

5. In a four-stroke cycle, four-cylinder reciprocating internal combustion engine having a crankshaft, four pistons, each reciprocal within a corresponding one of the cylinders, an intake poppet valve and an exhaust poppet valve for each cylinder, an intake camshaft for operating the intake valves, and an exhaust camshaft for operating the exhaust valves, the exhaust camshaft having primary lobes, each primary lobe normally opening the corresponding exhaust valve during an exhaust stroke of the corresponding piston, a method for internally recirculating exhaust gases, the method comprising:
communicating exhaust gasses from the cylinders to an undivided exhaust manifold; and
re-opening the exhaust valve near an end of an intake stroke of the corresponding piston, and allowing a pressure pulse in the exhaust manifold to cause a portion of the exhaust gases in the exhaust manifold to recirculate back into the corresponding cylinder.

6. The method of claim 5, further comprising:
closing the intake valve slightly before the exhaust valve is closed by the secondary lobe.
